(19) United States
(12) Patent Application Publication
(10) Pub. No.: US 2009/0228348 A1
(43) Pub. Date: Sep. 10, 2009

(54) PRIVACY FILM FOR MAINTENANCE OF DATA

(75) Inventors: Mark WOOLSTON, Copper Canyon, TX (US); Walter Hosiner, Rogersville, MO (US)

Correspondence Address: MCDERMOTT WILL & EMERY LLP, 600 13TH STREET, N.W., WASHINGTON, DC, 20005-3096, US

(73) Assignee: BOWE BELL + HOWELL COMPANY

(21) Appl. No.: 12/044,662

(22) Filed: Mar. 7, 2008

(51) Int. Cl. G06F 7/00; B07C 5/00; G03C 1/825

(52) U.S. Cl. 705/12; 209/576; 700/223; 430/510

(57) ABSTRACT

The present subject matter relates to an item and related method and system for validating the authenticity of sensitive data respective to the item for associated processing on a high speed item transport device. The sensitive data associated with the item to be processed is exposed to energy, such as a particular range of light, for validation at high volumes while maintaining data anonymity; but the data is otherwise obscured from view by a filter material that blocks light outside the range. Furthermore, verification of the sensitive data is performed without necessitating significant mechanical configuration changes or item manipulation techniques.

### TECHNICAL FIELD

The subject matter discussed herein relates to an item and related method and system for verifying the authenticity of sensitive data respective to the item for associated processing on high speed item transport devices.

### BACKGROUND

There are a number of document processing applications that require verification of authenticity of incoming items—-i.e., envelopes, packages, documents—or data thereon. In some cases, verification must be performed prior to opening the envelope or other type of item bearing the respective document. For example, there is an increasing trend in the United States for voting-by-mail (VBM), a process whereby ballots are sent to registered voters via the postal authority (e.g., United States Postal Service or “USPS”) and then returned by said voters by post or by dropping them off at designated ballot collection centers. Generally, the return envelope containing the ballot may itself require a voter signature or may enclose an item requiring the signature as a means of verifying voter authenticity prior to processing the ballot. As another example, various sensitive documents such as Internal Revenue Service tax documents, legal agreements and the like may also require the placement of a signature, initials, or other sensitive data respective to the documents for the purpose of verification of signer authenticity.

Generally, the location upon the envelope or item where the sensitive data (e.g., a signature) is to be placed is concealed, such as by application of the envelope flap over the sensitive data or as a result of enclosure of the item containing the sensitive data within the envelope. This is done in an effort to maintain data anonymity during the incoming and initial processing phases of the items. For instance, in the case of a VBM procedure, the voter signature on the mail item is concealed to protect voter privacy throughout USPS processing and/or processing by the elections office. To proceed with subsequent validation processing, however, the item must be manually or mechanically manipulated so as to reveal the voter signature. This may entail cutting or folding of the envelope flap to reveal the signature, opening of the envelope to permit removal of the enclosed item upon which the signature is affixed, removal of a sticker overlapping the signature, etc.

To the extent such processing is performed manually, it is obvious that such processing steps require additional time and physical exertion to complete the overall vote tabulation process. To the extent such processing is performed mechanically, such as via the usage of differing types of document processing equipment, envelope cutter systems or the like, the above described processing steps increase the likelihood of jams and mechanical errors. Not to mention, configuration settings for such equipment must be readily adapted to accommodate differing envelope designs—i.e., a first precinct may require cutting of its unique envelope across a first seam while a second precinct may require cutting of its unique envelope across a different seam for enabling exposure of sensitive data (e.g., a signature). Suffice to say, there is currently no efficient means by which sensitive data associated with an item to be processed may be readily exposed for validation at high volumes while maintaining data anonymity within a document processing environment. Furthermore, there is no current means by which the verification of sensitive data may be performed seamlessly without necessitating significant mechanical configuration changes or item manipulation techniques.

### SUMMARY

The subject matter discussed herein relates to a method for processing sensitive data associated with an item during the processing of the item by a document processing device. The method includes exposing a face of the item, such that the face of the item includes a filter material capable of restricting the passage of energy through the filter material corresponding to a wavelength required for human visibility of the sensitive data. Energy is produced at a wavelength required for visibility of the sensitive data through the filter material. An image of the sensitive data is acquired through the filter material and the imaged sensitive data is interpreted. Subsequent operation of the document processing device is controlled with regard to the item, based at least in part on the interpreting step.

Another aspect includes an item for maintaining confidentiality of sensitive data. The item includes sensitive data and an opening located along the item for exposing the sensitive data. A filter material is positioned adjacent to the opening wherein. The filter material restricts passage of energy through the filter material corresponding to a wavelength required for human visibility of the sensitive data; and also permits visibility of the sensitive data upon exposure to energy corresponding to a wavelength not restricted by the filter material.

Yet another aspect includes a system for processing an item including sensitive data. The system includes a document processing device for processing the item. The item includes a face including a filter material capable of restricting the passage of energy through the filter material corresponding to a frequency range required for human visibility of the sensitive data. An imaging device is included for acquiring an image of the sensitive data through the filter material as the item is processed by the document processing device. The imaging system is capable of producing energy at a wavelength not filtered by the filter material to permit optical access of the sensitive data by the imaging device through the filter material. An image processor is associated with the imaging device for interpreting the imaged sensitive data and a control processor is included for controlling subsequent operation of the document processing device on the item, based at least in part the interpretation.

### BRIEF DESCRIPTION OF THE DRAWINGS

The following detailed description of the embodiments of the present subject matter can best be understood when read in conjunction with the following drawings, in which the various features are not necessarily drawn to scale but rather are drawn as to best illustrate the pertinent features, and in which like reference numerals are employed throughout to designate similar features.

FIG. 1 depicts an exemplary item comprising a filter material suitable for restricting the passage of energy corresponding to a wavelength range required for human visibility of sensitive data marked on the item adjacent to said filter material but suitable for passage of energy of other wavelength for imaging the data;

FIG. 2 depicts the exemplary energy ranges corresponding to the electromagnetic spectrum for use in enabling visibility of sensitive data located adjacent to the filter material of FIG. 1;

FIG. 3 is an exemplary graph depicting the spectral filter response of differing mediums at differing intensity levels;

FIG. 4 depicts an exemplary item processing system for processing the item of FIG. 1; and

FIG. 5 depicts a flow diagram for processing sensitive data associated with an item.

### DETAILED DESCRIPTION

As used herein, the term “item” refers to any article or enclosure having human or machine readable content generated thereon or therein, and particularly that intended for delivery to a designated recipient. In the context of a general document processing facility, this may include envelopes, newsletters, newspapers, magazines, post cards, parcels or packages of varying thicknesses (e.g., flat mail), coupon booklets, brochures, documents of various types and associated quantity and other such articles. This may also include those articles having or associated with content representative of or intended for use in facilitating transactional affairs such as ballot cards, voter registration materials, tax related documentation, securities, corporate filing and registration documentation, accounting documentation and other like items of an often sensitive, confidential or official nature. Such items may or may not be generated for the purpose of being distributed via an outgoing distribution channel (e.g., delivery company, postal authority), but rather, may be generated for direct/personal carry, delivery, or internal distribution.

Still further, in the context of the examples herein, items may be configured for direct processing and conveyance of sensitive data, or alternatively, configured to enclose other items (e.g., documents) that convey sensitive data as marked thereon. In the latter case, the item may be a post card, package or the like that may be processed directly, while in the former the item having the sensitive data is contained within an envelope or package. Regardless of the configuration, it will be seen that the exemplary concepts presented herein pertain to any configuration of an item wherein the processing of sensitive data as associated with said item is required.

“Sensitive data” refers to any information deemed to be of interest for enabling processing of items for the purpose of engaging or authorizing a particular undertaking or transaction. In most instances, when sensitive data is contained within an item-i.e., when the item is in the form of an envelope or enclosure—or marked thereon, this serves as express acknowledgement or authorization of the transaction or undertaking. As this data is also application specific—i.e., a voter signature as is necessary to enable a vote-by-mail transaction—it is a data of interest in performing further processing of associated items having such data. Also, in some instances, the sensitive data may be that which is generally to be maintained and/or processed in a confidential and/or anonymous manner, particularly with respect to human perception of said data. Various well known types of sensitive data may include, but are not limited to signatures or initials, barcodes, uniquely assigned identifier values such as passwords or user codes, credit card numbers, fingerprint data, addresses, logos, etc., whether the sensitive data is in computer, typed/printed or handwritten form. With this in mind, the exemplary concepts herein pertain to the processing of any type of sensitive data. Accordingly, any data of interest for processing a mail item respective to a particular application or transactional need may benefit from the examples presented herein

Also, as presented herein, the processing of items containing or having sensitive data marked thereon is performed by a “document processing system.” Such systems refer to any high speed item transport device(s) capable of processing items at considerably high rates with considerably high precision. This includes processing capability for items in various forms ranging from envelopes to magazines to single documents of varying paper stock. Types of document processing systems may include, but are not limited to, inbound sorting equipment, outbound mail sorting equipment, and even various forms of inserter machines, mail integrity systems, or the like for office, commercial, or industrial settings. A “stacker,” “tray”, “bin” or “pocket” as used in connection with a document processing system may refer to any device for receiving, accumulating and/or collecting processed items or items to be processed. While the foregoing discussion will present the teachings in exemplary fashion with respect to a conventional sorter device, it will be apparent to those skilled in the art that the teachings may apply to any type of document processing device or system (e.g., inserter, accumulator, etc.) intended for use or aide in the verification of sensitive data and the handling of items conveying such data.

With this in mind, the following description refers to numerous specific details which are set forth by way of examples to provide a thorough understanding of the relevant teachings. It should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings. It will be appreciated by those versed in the art that the exemplary teachings described herein enables sensitive data to be imperceptible to the human eye for privacy protection purposes.

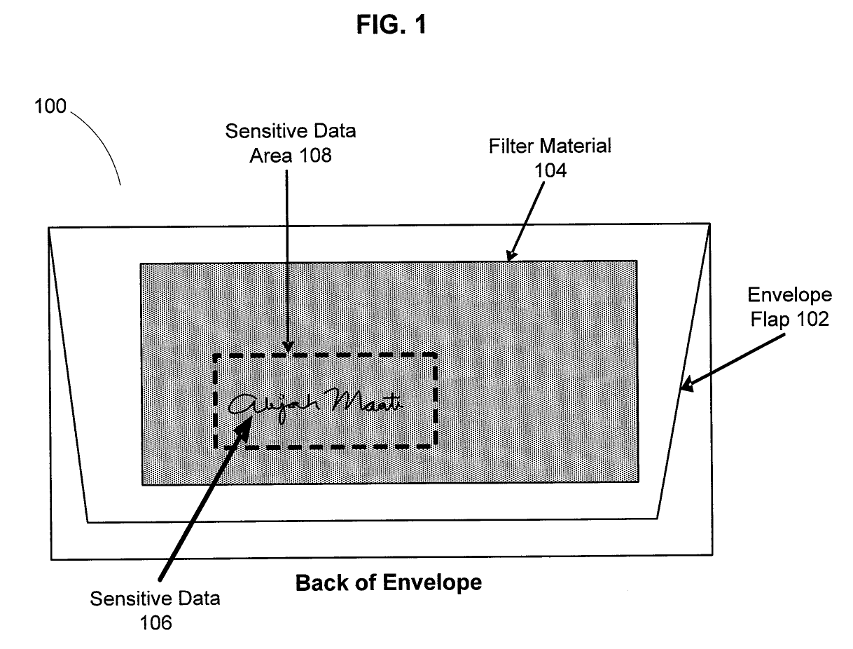

Turning now to FIG. 1, an exemplary item which includes a filter material suitable for restricting the passage of energy corresponding to a wavelength range required for human visibility of sensitive data marked adjacent to the filter material is depicted. The filter material restricts passage of such energy as to effectively obscure sensitive data shielded by the filter material from human view. In this particular example, the item 100 is an envelope having an attached flap 102, which folds to the back of the envelope for the sealing of contents therein. Of course, as stated previously, the item may be various other types of articles or enclosures suitable for enabling the distribution of contents, including flats having multiple faces—i.e., front face, back face, side face(s), bottom and top faces.

Generally, an item in the form of an envelope is composed of a select paper stock, such as that used for general mail correspondence. In accord with the examples presented herein, however, a portion of the envelope comprises a filter material—in this case the envelope flap 102—wherein the filter material 104 is capable of filtering electromagnetic energy at wavelengths corresponding to the visible spectrum. The filter material 104 can be applied onto the item 100 (e.g., in another location on the envelope) or envelope flap 102 in the same manner as typical clear envelope window material (i.e. cellophane, glassine, etc). During the item 100 manufacturing process, this filter material 104 is applied atop, under or adjacent to a desired location 108 or opening within the item that is proximate to the sensitive data 106; exposing the sensitive data suitably for reading during processing of the item 100. In the case of a flat having multiple faces, for instance, the filter material may correspond to any face.

A non-limiting example of a filter material includes an optically clear substrate, including an acetate thin film. The thickness of the substrate can vary, but as an example, an acetate thin film can have a thickness of about 0.0015″. The thin film substrate is coated with one or more optical dyes. An example of a first dye is E-Colour 106 Primary Red (Rosco Laboratories Inc., Stamford, Conn.) which passes energy above 610 nm. An example of a second dye is E-Colour 181 Congo Blue (Rosco Laboratories Inc., Stamford, Conn.), which blocks energy between 500 nm to 720 nm. This double dyed thin film acetate example yields a material that blocks all visible light (approximately 380 nm to 720 nm) and passes infrared (IR). Various other filter materials may be utilized for rendering the same effect. Indeed, those skilled in the art may employ various other techniques and/or methods for restricting the passage of energy at a frequency perceptible to the human eye.

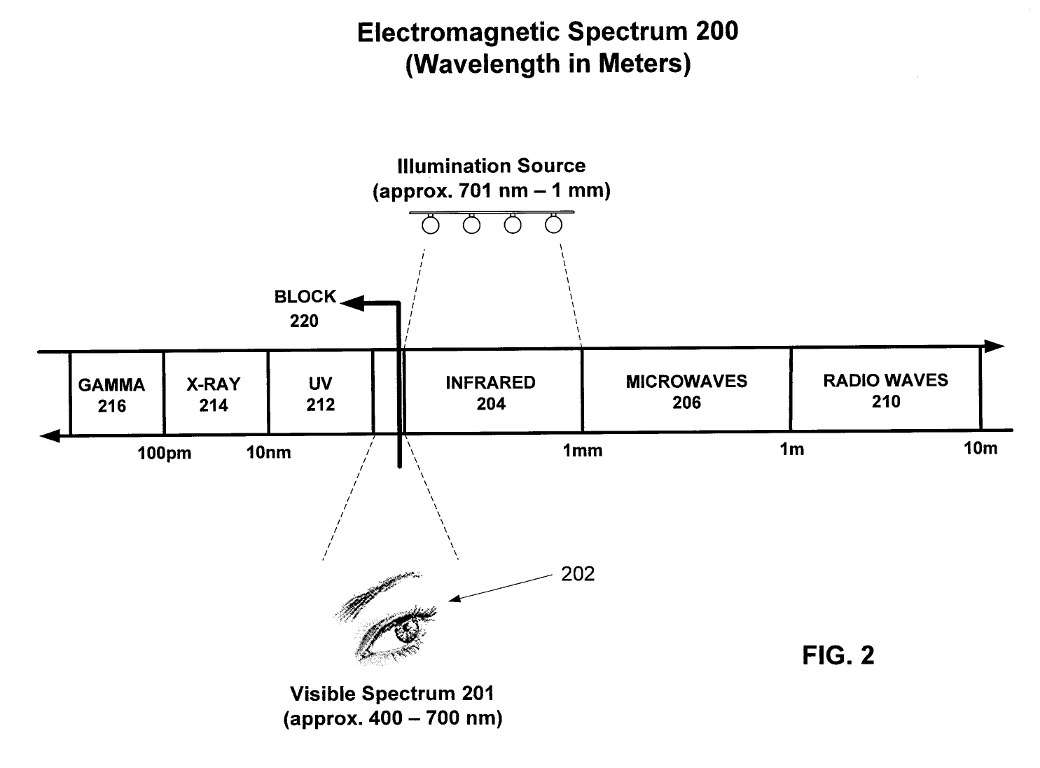

The visible spectrum, sometimes referred to as the optical spectrum, is the portion of the electromagnetic energy spectrum that can be detected by the human eye. The various energy ranges corresponding to the electromagnetic spectrum are depicted in FIG. 2. Electromagnetic energy of a wavelength corresponding to the visible spectrum 201 of wavelengths is called visible light or simply light. A typical human eye 202 will respond to wavelengths in a medium such as air in the range of approximately 400 nanometers to 700 nanometers. In terms of frequency, this corresponds to a band in the vicinity of 400-790 terahertz. The infrared spectrum 204, corresponding to the approximate range of 701 nanometers to 1 micrometer, lies just outside of the human response window 201, while the microwave 206 and radio wave spectrum 208 are far beyond the human response region. The ultraviolet, x-ray and gamma spectrums 212, 214 and 216 respectively are also outside of the range of human visibility.

With this in mind, the filter material 104, being composed of a material not corresponding to the human response region 201, functions as a privacy window of sorts as placed upon the envelope that obscures sensitive data 106 located adjacent to the filter material 104 from human recognition. To obscure or prevent human visual interpretation 202 of the sensitive data 106, the filter material 104 may be composed of a material corresponding to any of the differing ranges of the electromagnetic spectrum 200 with the exception of the visible spectrum 202. For example, the filter material suppresses electromagnetic waves (energy) below approximately 680 nanometers. This is indicated by way of example via arrow 220, which points in the direction of the ranges along the electromagnetic spectrum 200 impacted by such filtering of energy by the filter material 104.

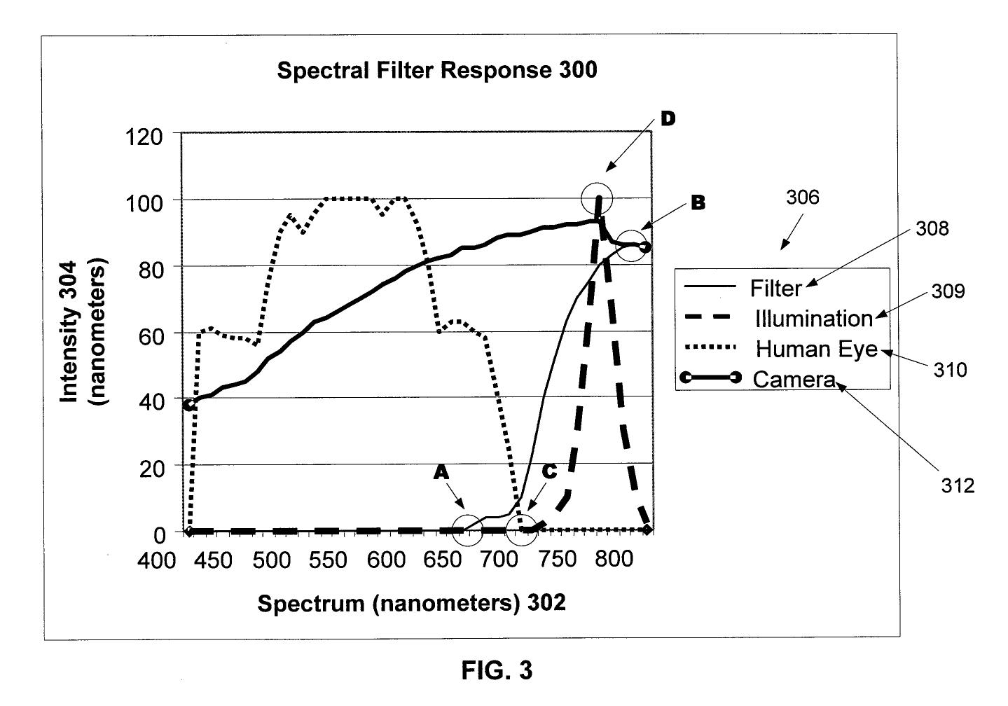

Suffice to say, energy directed towards the filter material 104 that corresponds to the visible spectrum 201 or below is blocked from passage, thus preventing human visibility of said sensitive data 106. Conversely, energy directed towards the filter material 104 of a wavelength/frequency range corresponding to the particular spectrum for which the filter material 104 is able to pass energy (e.g., above 680 nanometers) through the filter, reflects off the item surface bearing the sensitive data and passes back through the filter material. This enables a means of visibility of the sensitive data 106 by a properly calibrated imaging system. For the sake of clarity, as will be recognized by skilled practitioners, the filter may enable human obscuring of any data of interest. More regarding the response of the filter material 104 and other mediums respective to differing energy sources (e.g., illumination sources) is discussed with respect to FIG. 3.

FIG. 3 is an exemplary graph depicting the spectral filter response 300 of differing mediums 306—i.e., whether they are passive or active filters within the electromagnetic spectrum (in nanometers)—at differing intensity levels (in nanometers) 304. In particular, the graph explores the response of the filter material 308, an illumination source 309, the human eye 310 and a camera system 312 to varying intensity levels. As described above and shown, the filter material 308 blocks energy below 650 nanometers. However, the material becomes increasingly active at roughly 680 nanometers [A], peaks at roughly 800 nanometers [B], and attenuates from there at higher wavelengths. Hence, the filter material 308 does not respond at any wavelength less than 680, and is suitable for filtering out wavelengths corresponding to the visible spectrum 201. As the energy wavelength increases, however, the filter material 308 starts becoming transparent, wherein at approximately 800 nanometers [B], the filter enables passage of around 85% of the electromagnetic energy directed towards it. The illumination source 309 output energy in the infrared 204 spectrum peaking around 780 nanometers [D], which as depicted, is sufficient to pass through the filter material 308. Contrast this response with that of the human eye 310, which only responds to increasing intensity 304, beginning at approximately 400 nanometers and zeros out at roughly 701 nanometers [C]. More regarding the spectral filter response of the camera 312 will be presented subsequently.

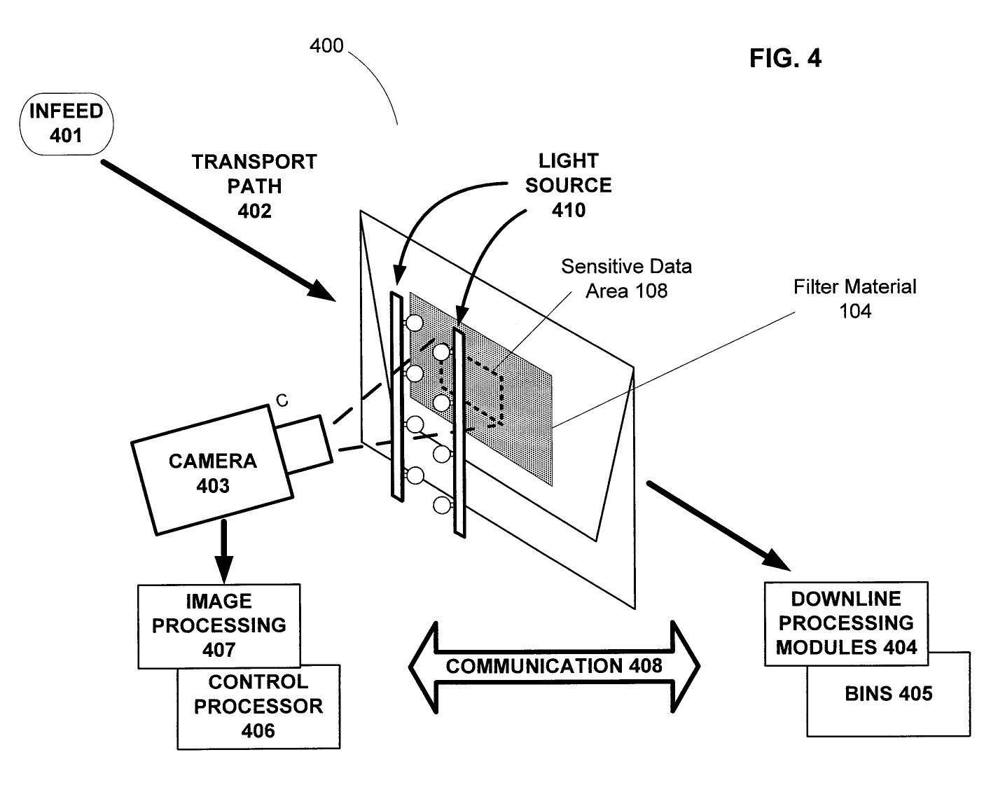

With reference now to FIG. 4, an exemplary high-level depiction of a document processing device 400 is shown comprising a camera 403 operating in connection with a light source 410 capable of generating energy at wavelengths corresponding to the filter material 308. Typically, the document processing device 400 may include various components, which in combination or in part enables the sensitive data to be detected via the use of the item as described. This document processing system may include an infeed system 401 for feeding a plurality of items along a transport path 402 ultimately to one or more downline processing modules 404 or bins 405. The system configuration may also include a control processor 406, which functions as a central control computer that regulates the operation of the document processing device 400. The control computer may further interface with image processing 407, which executes various instructions for interpreting images acquired by camera 403.

As documents are transported along transport path 402, they may be imaged by the imaging device 403, which in the case of FIG. 3 has a broad spectral response ranging from 400 nanometers to well above 800 nanometers. As such, the imaging device 403 is able to capture an image of the sensitive data 106 that is placed behind the filter material 104 provided that the correct illumination is supplied by light source 410. A suitable illumination source 410 may consist of a bank of Light Emitting Diodes (LED's) or other light source suitable for producing energy within the infrared spectrum 204 peaking around 780 nanometers [D]. This corresponds to the spectral range depicted in FIG. 3. As such, the energy produced by the LED's is in the range of the spectrum 302 that will pass through the filter material 104, allowing the energy emitted by the LED's 410 to reach the sensitive data 106 positioned in location 108 behind the filter material 104 and reflect back through the material 104 for detection by the camera 403. In the case of the exemplary envelope of FIG. 1, this would enable the sensitive data—i.e., the signature of ‘Alijah Maati’—to be acquired by the camera 403 for further processing. Likewise, other data obscured by the filter yet placed within the proximity of the sensitive data or range of the imaging system may also be captured. Those skilled in the art will recognize that the camera system 403 employed need be properly calibrated respective to the applied light source for acquisition of the sensitive data.

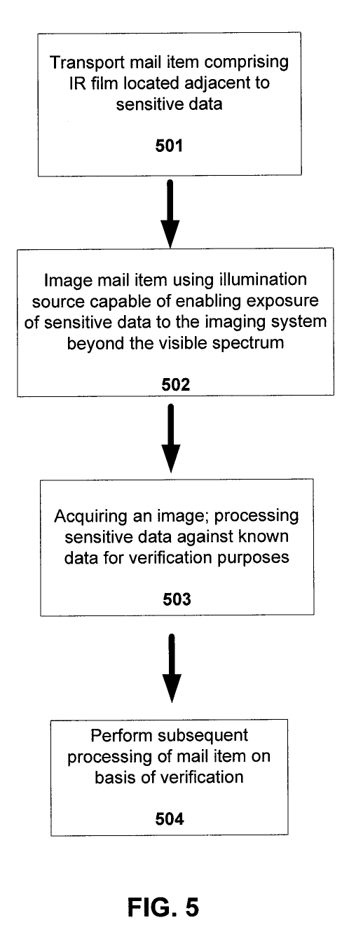

FIG. 5 depicts an examplary flow diagram for processing sensitive data associated with an item during processing of the item on a document processing device. Step 501 includes transporting an item on document processing equipment. The item includes filter material on an exposed face of the mail item. Step 502 includes illuminating the mail piece with an illumination source capable of producing energy beyond the visible spectrum. Upon illumination of the mail item, an image of the sensitive data is acquired through the filter material (Step 503). Step 503 further includes comparing the imaged sensitive data against stored historical data representative of the sensitive data. In Step 504, the operation of the document processing device is subsequently controlled based on the results of the comparison step. This may include sorting the item to the appropriate mail sort bin, controlling the operation of subsequent processing modules intended for operation upon the item such as a printer, labeler or postage meter. etc.

Examples of sensitive data read through the filter may include a voter signature and a unique identification mapped to the voter identification. Using the unique identification, a reference signature image will be retrieved from a database and compared with the signature image captured from the envelope. The precinct number corresponding to the voter will also be looked up in a database. In addition to this, the thickness of the item will also be measured to determine if there is more than one ballot (or no ballot) in the item. These three parameters (signature verification result, precinct number and thickness of the envelope) will then be used to determine the mail item sort bin that the mail item will be sorted to.

Also, those skilled in the art will recognize that Steps 503 and 504 may also apply to the processing of any data, including that not expressly deemed sensitive data. For example, sensitive data in the form of a private signature may also be accompanied by a postal authority approved barcode. Postal authority approved barcodes are often utilized within the public domain. In acquiring image data of both these items, the barcode may be used to direct the item to a bin designated for accumulating only select items. Where the other data is say a precinct number as referred to above, mail pieces may be sorted accordingly and processed respective to the signature for achieving a final level of sort. Suffice to say, the examples presented herein are applicable to all types of data.

Those skilled in the art will recognize that the above described configuration for the document processing device 400 is exemplary in nature. Indeed, any means by which an imaging device may be employed to capture sensitive data respective to an illumination source corresponding to a spectrum range outside of the visible spectrum is within the scope of the present teachings. Indeed, it will be appreciated by skilled practitioners that the exemplary item configuration presented enables usage of “privacy” windows in envelopes that allow automation equipment to still employ a variety of data contained within an envelope, yet keep it safe from the common observer. This capability is achieved through the effective use of special wavelength filter material and electromagnetic energy outside the visible range of the human eye.

As shown by the above discussion, many of the functions relating to the processing of images and/or capture data and relating control of the document processing system 400 are implemented by one or more computers, which of course may be connected for data communication (at 408) via the components of a network. The hardware of such computer platforms typically is general purpose in nature, albeit with an appropriate network connection for communication with other system elements or equipment and/or for communication via the intranet, the Internet and/or other data networks.

As known in the data processing and communications arts, each such general-purpose computer typically comprises a central processor, an internal communication bus, various types of memory (RA, ROM, EEPROM, cache memory, etc.), disk drives or other code and data storage systems, and one or more network interface cards or ports for communication purposes. The computer system also may be coupled to a display and one or more user input devices (not shown) such as alphanumeric and other keys of a keyboard, a mouse a trackball, etc. The display and user input element(s) together form a service-related user interface, for interactive control of the operation of the computer system. These user interface elements may be locally coupled to the computer system, for example in a workstation configuration, or the user interface elements may be remote from the computer and communicate therewith via a network. The elements of such a general-purpose computer system also may be combined with or integrated into a document processing system 400 as in FIG. 4 or even into the image processing as the sorting and/or inserting equipment.

The software functionalities involve programming, including executable code as well as associated stored data. The software code is executable by the general-purpose computer that functions as the data processor. In operation, the executable program code and the associated verification data are stored within the general-purpose computer platform. At other times, however the software may be stored at other locations and/or transported for loading into the appropriate general-purpose computer system. Hence, the embodiments involve one or more software products in the form of one or more modules of code. Execution of such code by an internal processor of the computer platform enables the platform to implement the verification system functions, in essentially the manner performed in the embodiments discussed and illustrated herein. With this in mind, the physical delivery location quality analysis need not be restricted to being performed by a centralized processing device, but may rather be performed as a distributed or shared processing task across a network of processing devices.

As used herein, terms such as computer or machine “readable medium” refer to any medium that participates in providing instructions to a processor for execution. Such a medium may take many forms, including but not limited to, non-volatile storage media, volatile storage media, and transmission media. Non-volatile storage media include, for example, optical or magnetic disks. Volatile storage media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

What is claimed:

1. A method for processing data associated with an item, during processing of the item by a document processing device, the method comprising steps of:
exposing a face of the item, the face of the item including a filter material capable of restricting the passage of energy through the filter material corresponding to a wavelength required for human visibility of the data;
illuminating the face of the item with energy produced at a wavelength required for visibility of the data through the filter material;
acquiring an image of the illuminated data through the filter material;
interpreting the imaged data; and
controlling subsequent operation of the document processing device with regard to the item, based at least in part on the interpreting step.

2. The method of claim 1, wherein the controlling step includes one or more of the following steps:
sorting the item to a designated item tray;
opening the item;
rejecting the item; and
labeling or printing material on the item.

3. The method of claim 1, wherein the acquiring step further includes acquiring an image of sensitive data as marked upon or within the item.

4. The method of claim 3, wherein the data as marked upon or within the item is selected from one or more of the following, in barcode or alphanumeric form: a precinct number, a voter registration number, a unique number assigned to a voter by an electoral authority.

5. The method of claim 1, wherein the interpreting step includes comparing the imaged data against historical data representative of the data as maintained by a database.

6. The method of claim 1, wherein the controlling step is based at least in part on the data as marked upon the item.

7. The method of claim 1, wherein the illuminating step includes generating energy at a wavelength included in infrared, microwave, radio wave, ultraviolet, x-ray or gamma ray spectrums.

8. A computer system programmed to implement the method of claim 1.

9. A software product comprising executable instructions for programming a computer to implement the method of claim 1, and a machine-readable storage medium bearing the instructions.

10. An item for maintaining confidentiality of sensitive data, the item comprising:
at least sensitive data;
a region located along the item for exposing the sensitive data; and
a filter material positioned adjacent to the opening wherein,
the filter material restricts passage of energy through the filter material corresponding to a wavelength required for human visibility of the sensitive data, and
the filter material permits visibility of the sensitive data upon exposure to energy corresponding to a wavelength not restricted by the filter material.

11. The item of claim 10, wherein the region is positioned along a front face, back face, side face, bottom or top face of the item.

12. The item of claim 10, wherein the opening is positioned proximate to the sensitive data.

13. The item of claim 10, wherein the sensitive data is marked on the item.

14. The item of claim 10, wherein the sensitive data is marked on contents within the item.

15. The item of claim 10, further comprising a fold-down flap.

16. The item of claim 15, wherein the fold-down flap includes the opening for exposing the sensitive data, the opening having affixed thereon the filter material.

17. The item of claim 10, further comprising an affixable label or window.

18. The item of claim 10, wherein the filter material is comprised of a thin film substrate coated with one or more optical dyes.

19. The item of claim 10, wherein the item is selected from an envelope, newsletter, newspaper, magazine, post card, parcel or package.

20. The item of claim 10, the wherein the filter material permits visibility of the sensitive data upon exposure to energy corresponding to a wavelength outside the visible spectrum, but included in t he infrared, microwave, radio wave, ultraviolet, x-ray or gamma ray spectrum.

21. A system for processing an item including sensitive data, the system comprising:
a document processing device for processing the item, the item having a face including a filter material capable of restricting the passage of energy through the filter material corresponding to a wavelength range required for human visibility of the sensitive data;
an imaging device for acquiring an image of the sensitive data through the filter material as the item is processed by the wavelength document processing device, the imaging system capable of producing energy at a wavelength not restricted by the filter material to permit optical access of the sensitive data by the imaging device through the filter material;
an image processor associated with the imaging device for interpreting the imaged sensitive data; and
a control processor for controlling subsequent operation of the document processing device on the item, based at least in part the interpretation.

22. The system of claim 21, wherein the controller controls operation of the document processing device to perform one or more of the following:
sorting of the item to a designated tray;
opening the item;
rejecting the item; and
labeling or printing material on the item.

23. The system of claim 21, wherein the document processing device is selected from a sorter, inserter or accumulator.

24. The system of claim 21, wherein the imaging device is a camera device associated with the image processor.
